(19) United States
(12) Patent Application Publication
(10) Pub. No.: US 2011/0064297 A1
(43) Pub. Date: Mar. 17, 2011

(54) MONITORING APPARATUS, MONITORING METHOD, INSPECTING APPARATUS AND INSPECTING METHOD

(76) Inventors: Naoshi SAKAGUCHI, Kawasaki-shi (JP); Masashi Takahashi, Yokohama-shi (JP); Takashi Watanabe, Nakagun (JP)

(21) Appl. No.: 12/718,355

(22) Filed: Mar. 5, 2010

Related U.S. Application Data
(63) Continuation of application No. PCT/JP2008/065969, filed on Sep. 4, 2008.

(30) Foreign Application Priority Data
Sep. 5, 2007 (JP) 2007-230374

(51) Int. Cl. G06K 9/00

(52) U.S. Cl. 382/141

(57) ABSTRACT

An inspecting apparatus according to the present invention has: an imaging section 30 for obtaining images of a first range and a second range of an inspection target object; the first range being shifted from the first range in a prescribed direction, a differential processing section 44 for obtaining a difference between signals of the image of the first range and that of the second range; and an inspecting section 46 for inspecting the existence of a defect in the inspection target object, based on processing results obtained from the differential processing section 44.

This is a continuation of PCT International Application No. PCT/JP2008/065969, filed on Sep. 4, 2008, which is hereby incorporated by reference. This application also claims the benefit of Japanese Patent Application No. 2007-230374, filed in Japan on Sep. 5, 2007, which is hereby incorporated by reference.

### TECHNICAL FIELD

The present invention relates to a monitoring apparatus, monitoring method, inspecting apparatus and inspecting method for such an inspection target object as a semiconductor wafer and liquid crystal glass substrate.

### TECHNICAL BACKGROUND

Recently the degree of integration of circuit device patterns formed on a semiconductor wafer is increasing, along with which the types of thin films used for surface treatment of the wafer in semiconductor manufacturing steps are increasing. Accordingly the defect inspection around the edge area of the wafer where boundary portions of the thin films are exposed is becoming critical. If there is such a defect as a foreign substance existing near the edge area of the wafer, the foreign object could wrap around to the front surface side of the wafer in subsequent steps and exert a negative influence, and the yield of the circuit devices diced from the wafer is affected as a result.

Therefore an inspecting apparatus which monitors an area around the end face (e.g. apex, top and bottom bevels) of a disk-formed inspection target object, such as a semiconductor wafer, from a plurality of directions, and inspects whether a defect, such as a foreign substance, pealing of film, a bubble in film, and the wraparound of film, exists (e.g. see Patent Document 1). This inspecting apparatus has a configuration to detect such a defect as a foreign substance using scattered lights generated by radiation of laser light, and a configuration to detect such a defect as a foreign substance by forming a band of an image of the inspection target object using a line sensor, for example.

Patent Document 1: Japanese Patent Application Laid-Open No. 2004-325389

### DISCLOSURE OF THE INVENTION

### Problems to be Solved by the Invention

There is an image acquisition apparatus to acquire each partial image of the area around the end face of the inspection target object using an image acquisition apparatus so as to detect such a defect as a foreign substance based on a plurality of image data, but if an image acquisition apparatus having a high resolution to recognize a small defect is used, the number of acquiring images (image data) becomes enormous, and if an end face (apex) is monitored using an 10× objective lens, for example, a number of acquiring images is about 1400. It takes time and is difficult to extract only image data having a defect of the inspection target object from such enormous image data by confirming images one by one.

With the foregoing in view, it is an object of the present invention to provide a monitoring apparatus, monitoring method, inspecting apparatus and inspecting method with which an image having a defect of an object can be easily extracted.

### Means to Solve the Problems

To achieve this object, a monitoring apparatus according to the present invention comprises: an imaging section for obtaining Images of a first range and a second range of an inspection target object; the first range being shifted from the first range in a prescribed direction; a differential processing section for obtaining a difference between signals of the image of the first range and that of the second range; and a display section for displaying a processing result obtained from the differential processing section.

In the monitoring apparatus, it is preferable that the differential processing section compares a signals of plurality of sections constituting the image of the first range with signals of a plurality of sections constituting the image of the second range, and obtains the respective differences in signal.

It is preferable that the monitoring apparatus further comprises a relative move section for relatively moving the inspection target object in the prescribed direction with respect to the imaging section, and is characterized in that the imaging section continuously obtains images of the inspection target object in the prescribed direction in according with the relative move.

It is also preferable that the relative move section rotates the disk-formed inspection target object around a rotation symmetrical axis thereof, so that an outer periphery edge section of the inspection target object moves toward the prescribed direction with respect to the imaging section, and the imaging section continuously obtains images of an outer periphery edge section of the inspection target object or a portion connected to the outer periphery edge section near the outer periphery edge section from at least one of a direction perpendicular to and a direction in parallel with the rotation axis.

It is also preferable that the imaging section obtains images of all around the circumference of the inspection target object. The imaging section may also obtain images of a part of the circumference of the inspection target object.

It is also preferable that the monitoring apparatus further comprises a histogram generating section that generates a histogram for indicating a relationship of the differential value obtained from the differential processing section and a position in the inspection target object corresponding to the images from which the difference is obtained.

It is also preferable that the images from which the difference is obtained based on a histogram can be displayed.

In the monitoring apparatus, it is preferable that the imaging section comprises a line sensor for obtaining images of the inspection target object, and the line sensor continuously obtains images of the inspection target object while relatively moving in the prescribed direction with respect to the inspection target object.

It is also preferable that the line sensor obtains images of a bright field image on the edge or near the edge of the inspection target object.

It is preferable that the monitoring apparatus comprises an imaging position setting section for setting a relative move range of the line sensor with respect to the inspection target object.

In the monitoring apparatus, it is preferable that the imaging section comprises a two-dimensional imaging unit for obtaining images of a two-dimensional image of the inspection target object, and the display section sets an imaging range of the two-dimensional imaging unit based on the processing result obtained from the differential processing section.

An inspecting apparatus according to the present invention comprises: an imaging section for obtaining images of a first range and a second range of an inspection target object; the first range being shifted from the first range in a predetermined direction; a differential processing section for obtaining a difference between signals of the image of the first range and that of the second range; and an inspecting section for inspecting the inspection target object based on processing results obtained from the differential processing section.

In the inspecting apparatus, it is preferable that the differential processing section compares signals of a plurality of sections constituting the image of the first range with signals of a plurality of sections constituting the image of the second range, and obtains the respective differences in signal.

It is preferable that the inspecting apparatus further comprises a display section for displaying processing results obtained from the differential processing section.

It is preferable that the inspecting apparatus further comprises a histogram generating section that generates a histogram for indicating a relationship of the differential value obtained from the differential processing section and a position in the inspection target object corresponding to the images from which the difference is obtained.

It is also preferable that the inspecting section determines the existence of a defect when the differential value Obtained from the differential processing section is greater than a prescribed threshold, and specifies a position of the defect based on the histogram generated by the histogram generating section.

In the inspecting apparatus, it is preferable that the imaging section comprises a line sensor for obtaining images of the inspection target object, and the line sensor continuously obtains images of the inspection target object while relatively moving in the prescribed direction with respect to the inspection target object.

It is also preferable that the imaging section comprises a two-dimensional imaging unit for obtaining images of a two-dimensional image of the inspection target object, and the display section sets an imaging range of the two-dimensional imaging unit based on the inspection result by the inspecting section.

It is preferable that the inspecting apparatus further comprises a recording section that records the two-dimensional image in which the defect images are shown by the two-dimensional imaging unit, and is characterized in that the inspecting section discerns a type of defect based on the differential value obtained by the differential processing section, according to the type of defect that is classified based on the two-dimensional image recorded in the recording section.

It is also preferable that the inspecting section extracts color information from the difference obtained from the differential processing section, and inspects the existence of the defect due to a thin film formed on the inspection target object, by inspecting the existence of a prescribed interference color based on the extracted color information.

A monitoring method according to the present invention comprises: an imaging processing step for obtaining images of a first range and a second range of an inspection target object; the first range being shifted from the first range in a prescribed direction; a differential processing step for obtaining a difference between signals of the image of the first range and that of the second range; and a display processing step for displaying a processing result obtained from the differential processing step.

In the monitoring method, it is preferable that in the differential processing section compares signals of a plurality of sections constituting the image of the first range with signals of a plurality of sections constituting the image of the second range, and obtains the respective differences in signal.

An inspecting method according to the present invention comprises: an imaging processing step for obtaining images of a first range and a second range of an inspection target object; the first range being shifted from the first range in a predetermined direction; a differential processing for obtaining a difference between signals of the image of the first range and that of the second range; and an inspection processing step for inspecting the inspection target object based on the processing results obtained from the differential processing step.

In the inspecting method, it is preferable that in the differential processing section compares signals of a plurality of sections constituting the image of the first range with signals of a plurality of sections constituting the image of the second range, and obtains the respective differences in signal.

In the inspecting method, it is preferable that in the inspecting processing step, the existence of the defect is determined when the differential value obtained from the differential processing step is greater than a prescribed threshold.

In the inspecting method, it is preferable that the imaging section for executing the imaging processing step comprises a two-dimensional image sensor and line sensor for obtaining images of the inspection target object, and is constituted to execute the inspecting processing step based on processing results of the differential processing step on the images of the inspection target object obtained by the line sensor, the method further executing: a threshold setting processing step for determining a correlation of the differential value obtained from the differential processing step on the image of the inspection target object obtained by the two-dimensional image sensor and a defect of the inspection target object that can be visually recognized in the image of the inspection target object obtained by the two-dimensional image sensor, and setting the threshold corresponding to the two-dimensional image sensor; and a threshold correcting processing step for correcting the threshold which is set in the threshold setting processing step and setting the threshold corresponding to the line sensor based on the differential value obtained from the differential processing step on the image of the inspection target object obtained by the line sensor, and setting the threshold corresponding to the line sensor.

In the inspecting method, it is preferable that the inspecting processing step is executed using a circuit board which can execute predetermined computing processing step.

### ADVANTAGEOUS EFFECTS OF THE INVENTION

According to the present invention, an image having a defect of the inspection target object can be easily extracted.

### BRIEF DESCRIPTION OF THE DRAWINGS

FIG. 1 is a diagram depicting a general configuration of an inspecting apparatus according to the present invention;

FIG. 2 is a side view depicting an area near the outer periphery edge portion of a wafer;

FIG. 3 is a control block diagram depicting an image processing section;

FIG. 4 is a flow chart depicting an inspecting method according to the present invention;

FIG. 5 is a flow chart depicting a threshold setting method that is used for the inspecting processing;

FIG. 6 is a diagram depicting steps of the segmenting processing and differential processing;

FIG. 7 is a diagram depicting a two-dimensional image of a wafer;

FIG. 8 is a diagram depicting a two-dimensional image of a wafer having a defect; and

FIG. 9 shows an example of a histogram.

### DESCRIPTION OF THE PREFERRED EMBODIMENTS

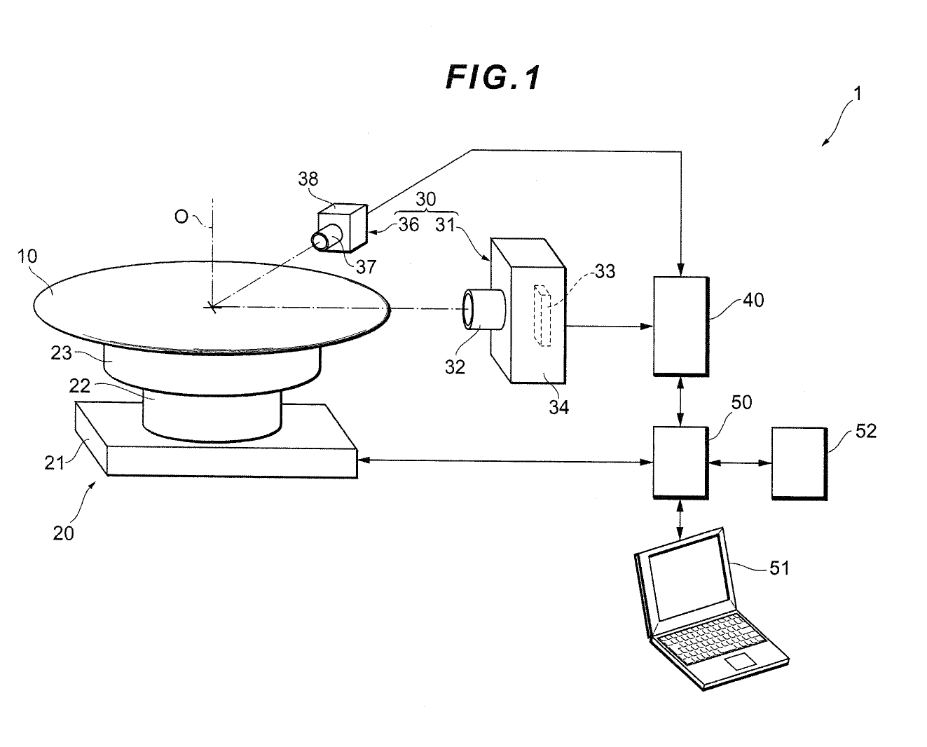

Preferred embodiments of the present invention will now be described. FIG. 1 shows an example of an inspecting apparatus according to the present invention, and this inspecting apparatus 1 is for inspecting the existence of a defect (e.g. scratch, adhesion of foreign substance) on the edge portion and near the edge portion of a semiconductor wafer 10 (hereafter “wafer 10”).

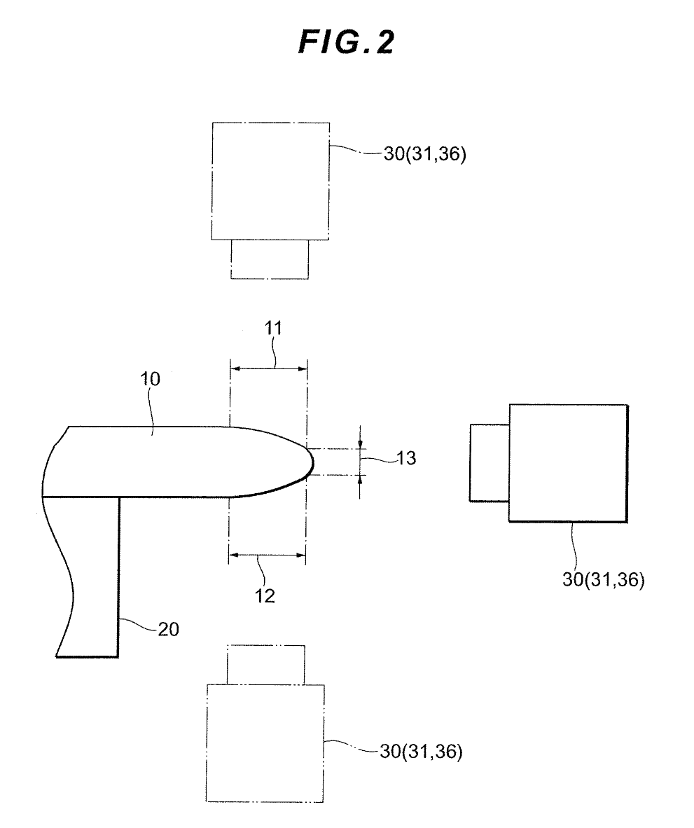

The wafer 10, which is an inspection target object, is formed as a thin disk shape, and on the surface thereof, thin films, such as an insulation film, electrode interconnect film, and semiconductor film (not illustrated) are formed in layers so as to generate a circuit pattern (not illustrated) corresponding to a plurality of semiconductor chips (chip area) which are diced when the wafer 10 is diced. As FIG. 2 shows, an upper bevel section 11 is formed as a ring shape, inside the outer periphery edge portion on the surface (top surface) of the wafer 10, and the circuit pattern is formed inside this upper bevel section 11. Inside the outer periphery edge portion on the rear face (bottom face) of the wafer 10, a lower bevel section 12 is formed to be symmetric with the upper bevel section 11 with respect to the wafer 10. The wafer end face connecting the upper bevel section 11 and the lower bevel section 12 becomes an apex section 13.

The inspecting apparatus 1 is comprised of a wafer support section 20 which supports and rotates the wafer 10, an imaging section 30 which obtains images of the outer periphery edge portion and an area near this portion of the wafer 10, an image processing section 40 which performs prescribed image processing on the image of the wafer 10 obtained by the imaging section 30, and a control section 50 which controls the driving of the wafer support section 20 and the imaging section 30, among others.

The wafer support section 20 is comprised of a base 21, a rotation axis 22 which extends vertically up from the base 21, and a wafer holder 23 which is installed approximately horizontally on the top end of the rotation axis 22 to support the wafer 10 by the top face thereof. A vacuum suction mechanism (not illustrated) is installed inside the wafer holder 23, so that the wafer 10 is held onto the wafer holder 23 by the vacuum suction of the vacuum suction mechanism.

A rotary drive mechanism (not illustrated) for rotary driving the rotation axis 22 is installed in the base 21, and by the rotary drive mechanism rotating the rotation axis 22, the wafer 10, held onto the wafer holder 23 by suction, along with the wafer holder 23 installed on the rotation axis 22, are rotary driven around the rotation axis, that is the center of the wafer 10 (rotation symmetrical axis O). The wafer holder 23 is created in a disk shape of which diameter is smaller than that of the wafer 10, so that an area around the outer periphery edge portion of the wafer 10, including the upper bevel section 11, lower bevel section 12 and apex section 13 extends out from the wafer holder 23 in a state where the wafer 10 is held onto the wafer holder 23 by suction. The wafer 10 is placed on the wafer holder 23 in a positioned state such that the center of the wafer 10 and the rotation axis are accurately aligned.

The imaging section 30 is comprised of a line sensor camera 31 and a two-dimensional camera 36 for imaging the wafer 10. The line sensor camera 31 is comprised of a lens barrel section 32 having an objective lens and epi-illumination, which are not illustrated, and camera main unit 34 in which a line sensor 33 is enclosed, so that the illumination light by epi-illumination is irradiated onto the wafer 10 via the objective lens, and the reflected light from the wafer 10 is guided into the line sensor 33 via the objective lens, and a linear image (linear image data) of the wafer 10 is detected by the line sensor 33. By this configuration, a bright field image of the outer periphery edge portion or an area near the portion of the wafer 10 is obtained.

The line sensor camera 31 is disposed so as to face the apex section 13 of the wafer 10, and images of the apex section 13 is obtained from a direction perpendicular to the rotation axis (rotation symmetrical axis O) of the wafer 10. If the wafer 10 supported by the wafer support section 20 is rotated, the outer periphery edge portion of the wafer 10, that is the apex section 13, rotates relatively in the circumferential direction of the wafer 10, with respect to the line sensor camera 31, therefore the line sensor camera 31 facing the apex section 13 can continuously obtain images of the apex section 13 in the circumferential direction, and the images of the apex section 13 can be obtained all around the circumference of the wafer 10. The line sensor camera 31 is disposed so that the longitudinal direction of the line sensor 33 faces in a direction approximately parallel with the rotation axis (rotation symmetrical axis O) of the wafer 10 (vertical direction).

The two-dimensional camera 36 for imaging the two-dimensional image of the wafer 10 is comprised of a lens barrel section 37 having an objective lens and epi-illumination, which are not illustrated, and a camera main unit 38 in which a two-dimensional image sensor, which is not illustrated, is enclosed, so that the illumination light by epi-illumination is irradiated onto the wafer 10 via the object lens, and the reflected light from the wafer 10 is guided into the two-dimensional image sensor via the objective lens, and a two-dimensional image (two-dimensional image data) of the wafer 10 is detected by the two-dimensional image sensor. By this configuration, a bright field image of the outer periphery edge portion or an area near the portion of the wafer 10 is obtained.

The two-dimensional camera 36 is disposed in a position which is shifted from the line sensor camera 31 in the circumferential direction of the wafer 10, and which faces the apex section 13 of the wafer 10, so as to obtain images of the apex section 13 from a direction perpendicular to the rotation axis (rotation symmetrical axis O) of the wafer 10. Therefore the two-dimensional camera 36 can continuously obtain images of (a plurality of images of) the apex section 13 in the circumferential direction, just like the case of the line sensor camera 31, and the images of the apex section 13 can be obtained all around the circumference of the wafer 10. The image data obtained by the line sensor camera 31 and the two-dimensional camera 36 are output to the image processing section 40.

The control section 50 is comprised of a control board for performing various controls, and performs activation control of the wafer support section 20, imaging section 30 and image processing section 40 or the like using control signals from the control section 50. The control section 50 is electrically connected to an interface section 51 having an input section for inputting inspection parameters (e.g. threshold used for defect detection), an image display section, and a storage section 52 which stores image data.

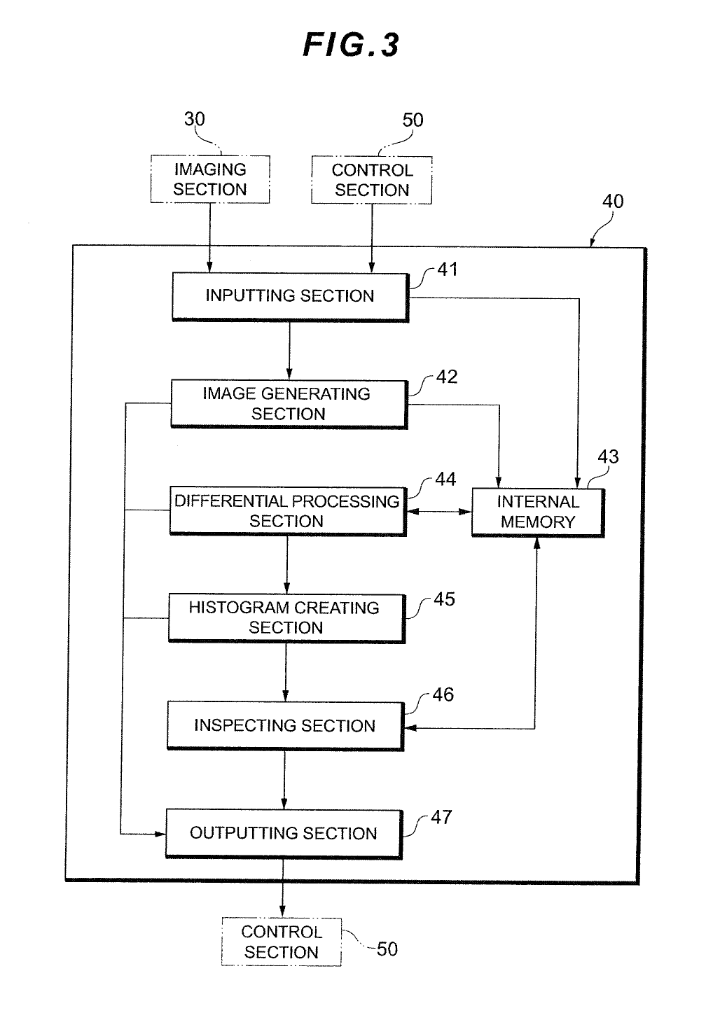

The image processing section 40 is comprised of a circuit board, which is not illustrated, and has an input section 41, image generating section 42, internal memory 43, differential processing section 44, histogram generating section 45, inspecting section 46 and output section 47, as shown in FIG. 3. To the input section 41, linear image data from the line sensor camera 31 and two-dimensional image data from the two-dimensional camera 36 are input, and inspection parameters or the like, being input by the interface section 51, are also input via the control section 50.

The image generating section 42 is electrically connected with the input section 41, and when a linear image data by the line sensor camera 31 is input from the input section 41, the image generating section 42 generates two-dimensional image data on the apex section 13 of the wafer 10 by combining the linear image data, which was continuously obtained in the circumferential direction of the wafer 10, and outputs the generated two-dimensional image data to the internal memory 43 and the output section 47. When the two-dimensional image data by the two-dimensional camera 36 is input from the input section 41, the image generating section 42 outputs the two-dimensional image data which was input to the output section 47 to display the image in the interface section 51.

The differential processing section 44 is electrically connected with the internal memory 43, executes the later mentioned differential processing on the two-dimensional image data, which is generated by the line sensor camera 31 and stored in the internal memory 43, and outputs the processing result to the histogram generating section 45 and output section 47. The histogram generating section 45 is electrically connected with the differential processing section 44, and generates a histogram on the difference based on the differential processing result, which is input from the differential processing section 44, and outputs the data on the generated histogram to the inspecting section 46 and the output section 47.

The inspecting section 46 is electrically connected with the histogram generating section 45, and when the data on the histogram is input from the histogram generating section 45, the inspecting section 46 executes inspecting processing for inspecting the existence of a defect in the wafer 10 based on the data (differential value) of the histogram which was input, and outputs the processing result to the output section 47. The output section 47 is electrically connected with the control section 50, and outputs the two-dimensional image data on the wafer 10, differential processing result by the differential processing section 44, data (image) of the histogram, inspection processing result by the inspection section 46, and so forth, to the control section 50.

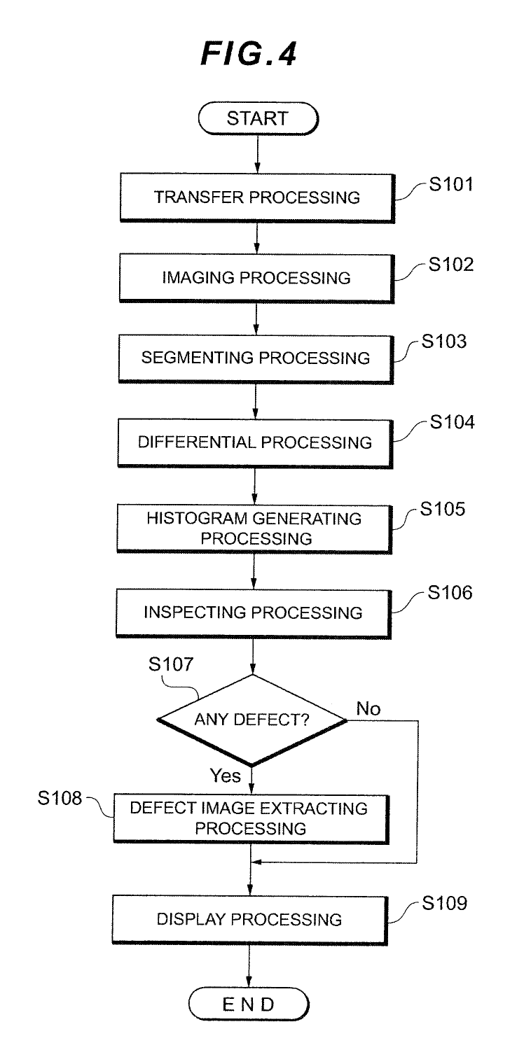

Now the inspecting method for the wafer 10 using the inspecting apparatus 1 having the above configuration will be described with reference to the flow chart shown in FIG. 4. First in step S101, a transfer processing for transferring a wafer 10, that is an inspection target object, to the wafer support section 20, is executed. In the transfer processing, the inspection target wafer 10 is transferred onto the wafer holder 23 on the wafer support section 20 by a transfer apparatus, which is not illustrated.

When the wafer 10 is placed on the wafer holder 23, an imaging processing for imaging the apex section 13 of the wafer 10 is executed in next step S102. In the imaging processing, the wafer support section 20, which received the control signal from the control section 50, rotates the wafer 10, and the line sensor camera 31 continuously obtains images of the apex section 13 (in the circumferential direction), which relatively rotates in the circumferential direction of the wafer 10, so that the images of the apex section 13 is obtained all around the circumference of the wafer 10.

When the line sensor camera 31 continuously obtains images of the apex section 13, the linear image data, which is continuously detected by the line sensor 33, is output to the image processing section 40, and the linear image data which was input to the input section 41 of the image processing section 40 is sent to the image generating section 42. When the linear image data generated by the line sensor camera 31 is input from the input section 41, the image generating section 42 generates two-dimensional image data on the apex section 13 of the wafer 10 by combining the linear image data which was continuously obtained in the circumferential direction of the wafer 10, and outputs the generated two-dimensional image data to the internal memory 43 and the output section 47. The two-dimensional image data which is output to the output section 47 is sent to the storage section 52 from the control section 50, and is stored in the storage section 52.

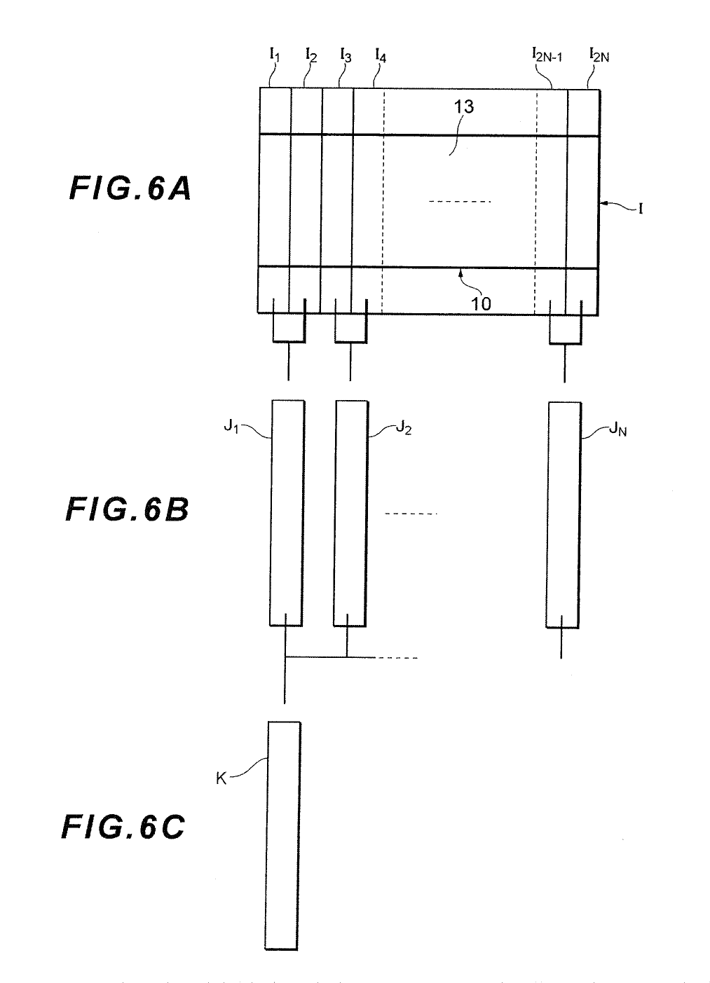

When the two-dimensional image of the apex section 13 is generated all around the circumference of the wafer 10 by the image generating section 42, a segmenting processing is executed in step S103, where, as FIG. 6A shows, the two-dimensional image I of the apex section 13 all around the circumference of the wafer 10 is segmented into 2×N (N is a natural number) number of rectangular images I₁ to I_{2N}, which lineup in the circumferential direction of the wafer 10, for example. The segmenting processing section 44 executes this segmenting processing on the two-dimensional image data stored in the internal memory 43.

The differential processing section 44 segments the two-dimensional image I of the apex section 13 into 2×N number of segmented images I₁ to I_{2N} and executes a differential processing for obtaining a difference between signals of an odd number of segmented images I₁, I₃, . . . I_{2N-1} counted from the left side of the two-dimensional image I and the signals of an even number of segmented Images I₂, I₄, . . . I_{2N}, which are shifted to the right from the odd number of images in the circumferential direction of the wafer 10 respectively (more specifically, the brightness of each segmented image) (step S104). In this differential processing, the differential processing section 44 executes the differential processing for each of the N pairs of adjacent segmented images, and at this time, (a plurality of) pixels constituting the odd number of segmented images I₁, I₃, . . . I_{2N-1} and (a plurality of) pixels constituting the even number of segmented images I₂, I₄, . . . I_{2N} are corresponded in the circumferential direction of the wafer 10, and the difference of the respective signals (for each pixel) is obtained.

When the difference of signals for each pixel is obtained like this, the differential processing section 44 creates N number of (rectangular) differential processing images J₁, J₂, . . . J_{N}, corresponding to N pairs of segmented images based on the differential value of the signals for each pixel, as shown in FIG. 6B, and by repeating the processing for obtaining the difference of signals between each differential processing image J₁, J₂, . . . J_{N}, generates one (rectangular) processing result image K, as shown in FIG. 6C. Then the differential processing section 44 outputs each of the generated differential processing images J₁, J₂, . . . J_{N} and the image data of the processing result image K to the histogram generating section 45 and the output section 47. The image data of each differential processing image J₁, J₂, . . . J_{N} and the processing result image K, which are output to the output section 47, are sent to the storage section 52 via the control section 50, and is stored in the storage section 52.

When the image data of each differential processing image J₁, J₂, . . . J_{N} is sent from the differential processing section 44 to the histogram generating section 45, the histogram generating processing is executed in the next step S105. In the histogram generating processing, the histogram generating section 45 generates a histogram to show the relationship between the differential value of signals (e.g. average value of the differential value of each pixel calculated for the N pair of segmented images) and the angle position in the apex section 13 corresponding to the segmented image from which this differential value is obtained (angle position corresponding to the polar coordinates of which origin is the center of the wafer 10) based on the image data of each differential processing images J₁, J₂, . . . J_{N}, that is, the differential value of signals for each pixel obtained in the differential processing, and outputs the data of the generated histogram to the inspecting section 46 and the output section 47. The data of the histogram that is output to the output section 47 is sent to the storage section 52 via the control section 50, and is stored in the storage section 52.

The differential value of signals constituting the histogram is not limited to the average value of the differential value of each pixel calculated for each of the N pairs of the segmented images, but may be a maximum value of the differential value of each pixel calculated for each of the N pairs of segmented images. The histogram using the average value is suitable for detecting a defect which is visibly similar to the wafer 10, such as a water droplet, and the histogram using the maximum value is suitable for detecting a localized defect, such as a scratch, so an appropriate differential value should be used depending on the type of defect to be detected.

When the data of the histogram is sent from the histogram generating section 45 to the inspecting section 46, the inspecting processing for inspecting the existence of a defect in the wafer 10 is executed in the next step, S106. In this inspecting processing, the inspecting section 46 judges whether each differential value of signals constituting the histogram is greater than a prescribed threshold stored in the internal memory 43. If all the differential values constituting the histogram are smaller than the prescribed threshold, it is judged that no defect exists in the images of the apex section 13 of the wafer 10 obtained by the line sensor camera 31. If any of the differential values in the histogram is greater than the prescribed threshold, on the other hand, it is judged that a defect exists in the apex section 13, and the angle position of the apex section 13, at which a differential value is greater than the threshold, is specified as a position having a defect, based on the data of the histogram.

The threshold that is used for the inspecting processing is determined experientially, and is input from the interface section 51, and is sent to the internal memory 43 via the control section 50 and the input section 41. The inspecting section 46 outputs the processing result of the inspecting processing to the output section 47, and the data of the inspecting processing result that is output to the output section 47 is sent to the storage section 52 via the control section 50, and is stored in the storage section 52.

In the next step S107, it is judged whether a defect exists in the apex section 13 of the wafer 10 as a result of the inspecting processing. If the judgment is NO, that is if no defect exists in the apex section 13 of the wafer 10 as a result of the inspecting processing, processing advances to step S109.

If the judgment is YES, that is if a defect exists in the apex section 13 of the wafer 10 as a result of the inspecting processing, processing advances to step S108, to execute a defective Image extracting processing to obtain a two-dimensional image of the defective portion. In this defective image extracting processing, the control section 50 sets an imaging range of the two-dimensional camera 36 based on an angle position in which the apex section 13, specified by the inspecting section 46, has a defect, and the two-dimensional camera 36 obtains images of a defective portion in the apex section 13 when a control signal, which the control section 50 outputs according to the setting of the imaging range, is received. The two-dimensional image data obtained by the two-dimensional camera 36 is output to the input section 41 of the image processing section 40, and is sent to the storage section 52 via the image processing section 40 (input section 41, image generating section 42 and output section 47) and the control section 50, and is stored in the storage section 52.

In step S109, the control section 50 has the image displaying section of the interface section 51 display data stored in the storage section 52, such as the processing result image K generated by the differential processing unit 44, the histogram generated by the histogram generating section 45 and the inspection processing result generated by the inspecting section 46.

The inspecting apparatus 1 and the inspecting method according to the present embodiment has differential processing for Obtaining a difference between signals of the first (odd number of) segmented images I₁, I₃, . . . I_{2N-1} and the second (even number of) segmented images I₂, I₄, . . . I_{2N} which are shifted to the next pixel from the first segment images I₁, I₃, . . . I_{2N-1} in a circumferential direction of the wafer 10 respectively, and inspecting processing for the inspecting the existence of a defect in the wafer 10 based on the processing results obtained in the differential processing, therefore it is unnecessary to visually monitor images of the wafer 10 one by one, and inspection of the wafer 10 (extraction of an image having a defect) can be executed easily in a short time. A separate non-defective image of the wafer 10 is not required, so the time and labor required for a non-defective image of the wafer 10 can be saved.

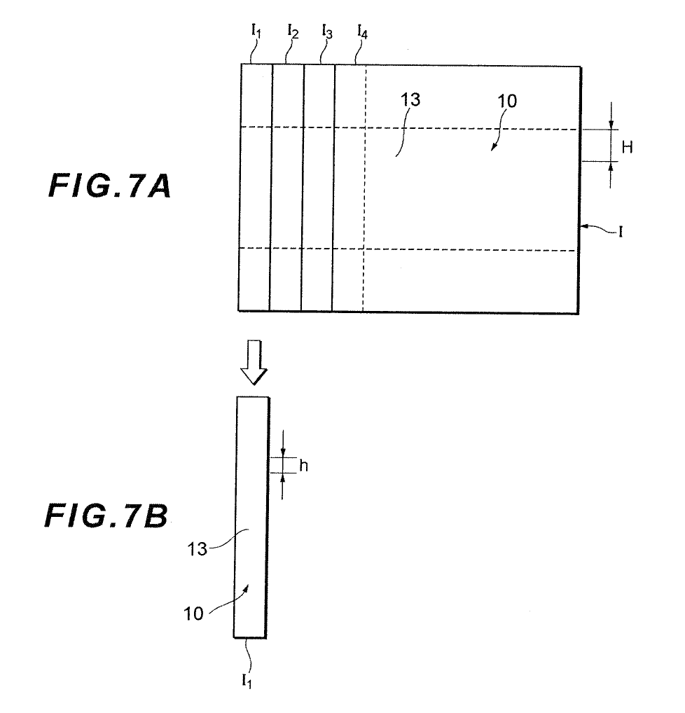

By obtaining the difference between signals of the first segmented image I₁, I₃, . . . I_{2N-1} and the second segmented image I₂, I₄, . . . I_{2N} which are shifted to the next pixel respectively from the first segmented image I₁, I₃, . . . I_{2N-1}, the vertical change amount h of the apex section 13 in each segmented image I₁, I₂ . . . becomes smaller than the vertical change amount II of the apex section 13 in the entire two-dimensional image I, even if the extending direction of the apex section 13 is inclined from the horizontal direction of the two-dimensional image I due to the warp of the wafer 10, for example, as shown in FIG. 7. Hence the influence of warp or similar defect, of the wafer 10, on inspection can be minimized.

As mentioned above, the processing result image K generated in the differential processing is displayed by the image display section of the interface section 51. The surface of the apex section 13 of the wafer 10 is flat and approximately uniform. Therefore if no defects exist in the apex section 13 of the wafer 10, the segmented images I₁ to I_{2N} aligned in the circumferential direction (extending direction of the apex section 13) of the wafer 10 are images that are similar to one another, as shown in FIG. 6A, and the differential value of signals of each pixel obtained in the differential processing become virtually zero, so each differential processing image J₁, J₂, . . . J_{N} becomes dark, where nothing is observed (see FIG. 6B). The processing result image K obtained by repeating the processing to obtain the difference of signals between each differential processing image J₁, J₂, . . . J_{N} also becomes dark, where nothing is observed (see FIG. 6C).

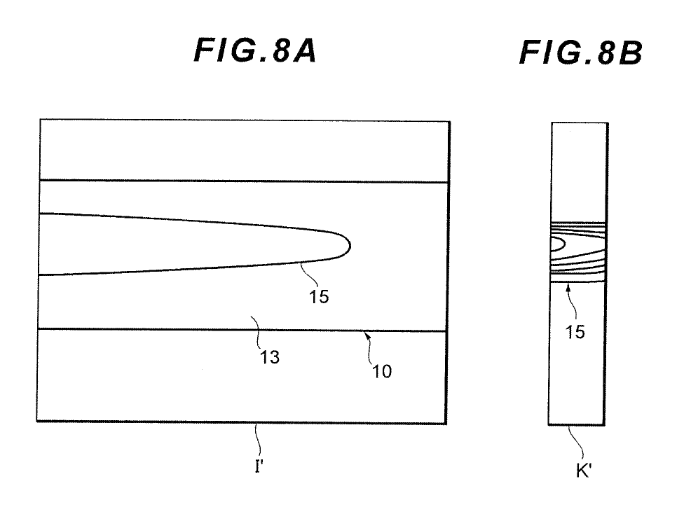

On the other hand, if a defect 15 exists in the apex section 13 in the two-dimensional image I′ of the apex section 13, as shown in FIG. 8A, the segmented images lined up in the circumferential direction of the wafer 10 are different images, depending on the shape of the defect 15, and the differential value of signals of each pixel obtained in the differential processing becomes relatively high in an area where a defect 15 exists, so the defect 15 is partially displayed in each differential processing image. Therefore in the processing result image K′ obtained by repeating the processing to obtain the difference of signals between each differential processing image, the portions of the defect 15 displayed in each differential processing image are overlapped and displayed, as shown in FIG. 8B. Thereby an existence of the defect 15 in the wafer 10 (apex section 13) can be easily recognized.

In the differential processing, if (a plurality of) pixels constituting the first (odd number of) segmented images I₁, I₃, . . . I_{2N-1} and (a plurality of) pixels constituting the second (even number of) segmented images I₂, I₄, . . . I_{2N} are corresponded respectively in the circumferential direction of the wafer 10 and the respective difference of the signals for each (pixel) is obtained, then the differential processing in a smaller range (with higher resolution) becomes possible, and according to the inspection (extraction of image having a defect) of the wafer 10 can be improved.

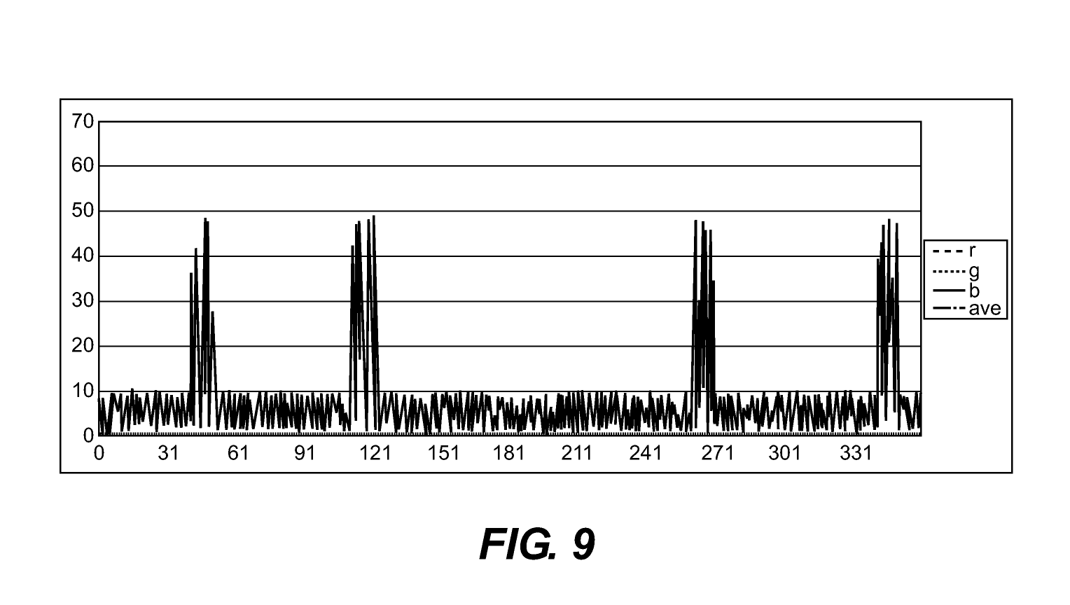

As mentioned above, a processing, to generate a histogram for showing the relationship of the differential value of signals obtained in the differential processing and the angle position in the apex section 13 corresponding to the segmented image from which this differential value is obtained, is included, and the histogram shown in FIG. 9, for example, is displayed in the image displaying section of the interface section 51. Thereby a position having a defect in the wafer 10 (apex section 13) can be easily recognized.

If the inspecting section 46 judges that a defect exists in the wafer 10 (apex section 13) when any differential value in the histogram is greater than a prescribed threshold, and also specifies the position having a defect based on the data of the histogram, then the existence of a defect in the wafer 10 (apex section 13) and a position having the defect can be automatically defected.

When a point at which the differential value is greater than a prescribed threshold is selected in the histogram, a two-dimensional image of a portion having a defect, obtained by the two-dimensional camera 36 (stored in the storage section 52) in the angle position in which the selected differential value is obtained, can be displayed. Therefore a detailed image including a defect can be observed when required.

Also as mentioned above, the images of the apex section 13 of the wafer 10 can be obtained at high speed by rotary-driving the wafer 10 using the wafer support section 20, and continuously imaging the apex section 13 of the wafer 10 in the circumferential direction using the line sensor camera 31 from a direction perpendicular to the rotation axis of the wafer 10.

Further, the existence of a defect can be judged all at once for the entire apex section 13 of the wafer 10 by imaging the apex section 13 all around the circumference of the wafer 10.

Also the bright field image of the apex section 13 can be obtained at high-speed by imaging the bright field image of the apex section 13 using the line sensor camera 31.

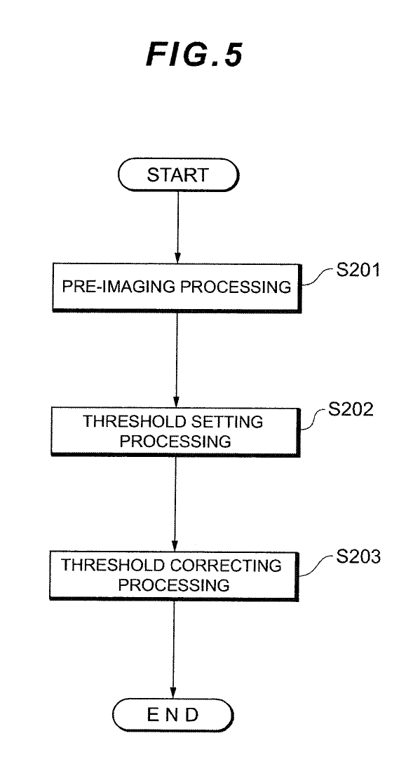

As described for the above embodiment, the threshold used for the inspecting processing is set experientially, and an example of a method for setting this threshold will now be described with reference to the flow chart in FIG. 5. In step S201, a pre-imaging processing for imaging the apex section of the wafer for setting the threshold (not illustrated) using the line sensor camera 31 and the two-dimensional camera 36 respectively is executed. In this pre-imaging processing, the line sensor camera 31 obtains images of the apex section of the wafer for threshold setting in the same manner as the imaging processing in step S101, and the two-dimensional camera 36 obtains images of the apex section of the wafer for threshold setting just like the case of the line sensor camera 31.

When the pre-imaging processing ends, the threshold setting processing is executed in step S202, so as to set a setting processing threshold for inspecting processing corresponding to the two-dimensional camera 36 (two-dimensional image sensor). In the threshold setting processing, the differential processing section 44 executes the above mentioned differential processing on the image of the wafer for the threshold setting (apex section) obtained by the two-dimensional camera 36. In the apex section of the wafer for threshold setting, a defect is artificially created, and the operator experientially sets a threshold for inspecting processing corresponding to the two-dimensional camera 36, by correlating the differential value of the signals obtained in the previous differential processing and a defect portion that can be visually recognized in the image of the wafer for threshold setting (apex section) obtained by the two-dimensional camera 36.

When the threshold setting processing ends, a threshold correction processing for setting a threshold for inspecting processing corresponding to the line sensor camera 31 (linear sensor 33) is executed in the next step S203. In the threshold correction processing, the differential processing section 44 executes the above mentioned differential processing on the image of the wafer for threshold setting (apex section) obtained by the line sensor camera 31. Based on the differential value of signals obtained in this differential processing, the operator corrects the threshold which was experientially set in the threshold setting processing, and sets a threshold corresponding to the line sensor camera 31. Thereby an appropriate threshold can be set.

When the threshold is set like this and inspecting processing is executed based on the result of the differential processing on the image of the wafer 10 (apex section 13) obtained by the line sensor camera 31 according to the above mentioned embodiment, the inspecting processing may be executed using a circuit board (not illustrated) that outputs the ON/OFF signal depending on whether the differential value of the signals is greater than the threshold or not, for example. Then the inspecting processing can be executed at a faster speed, and the wafer 10 can be inspected (extraction of an image having a defect) in a shorter time.

In the above experiment, the type of defect may be classified based on the two-dimensional image, displaying a defect of the wafer 10, which was obtained by the two-dimensional camera 36 and stored in the storage section 52, so that the type of defect is discerned by the differential value of the signals, which were obtained from the differential processing, in the inspecting processing. Then the type of defect can be discerned in a shorter time based on the result of the differential processing on the image of the wafer 10 (apex section 13) obtained by the line sensor camera 31, without visual checking of the two-dimensional image.

In the inspecting processing, the existence of a defect due to a thin film formed on the wafer 10 may be inspected by extracting color information on r (red), g (green) and b (blue) as shown in the histogram in FIG. 9, for example, and inspecting the existence of a prescribed interference color (obtained by the two-dimensional camera 36) based on the extracted color information.

In the above embodiment, the apex section 13 is obtained all around the circumference of the wafer 10, but the present invention is not limited to this, and the images of a desired range of the angle positions in the apex section 13 may be obtained by activation control of the control section 50. Thereby the existence of a defect can be inspected for a desired range of angle positions of the apex section 13.

The width of the segmented image in the segmenting processing may be changed depending on the range of the angle positions of the apex section 13 by the activation control of the control section 50. Then the inspection accuracy can be changed depending on the desired range of the angle positions of the apex section 13.

In the above embodiment, the line sensor camera 31 and the two-dimensional camera 36 of the imaging section 30 obtain images of the apex section 13 of the wafer 10, but the present invention is not limited to this, and the images of the upper bevel section 11 of the wafer 10, for example, may be obtained, as indicated by the dashed line in FIG. 2, or the images of the lower bevel section 12 of the wafer 10 may be obtained, as indicated by the two dot chain line in FIG. 3. In this way, the existence of a defect can be inspected not only in the apex section 13 of the wafer 10, but also in the upper bevel section 11 or lower bevel section 12. The inspection area is not limited to the outer periphery edge portion or an area near the outer periphery edge portion of the wafer 10, but may be a glass substrate, for example, and the present embodiment is particularly effective for application to an inspection target object of which surface form is generally uniform.

In the above embodiment, the differential processing section 44 is constructed such that one processing result image K is generated by repeating the processing to obtain the difference of signals on each differential processing image J₁, J₂, . . . J_{N}, but the present invention is not limited to this, and one processing result image K may be generated by superimposing each differential processing image J₁, J₂, . . . J_{N} respectively.

In the above embodiment, inspecting processing is executed based on the result of the differential processing on the wafer 10 (apex section 13) obtained by the line sensor camera 31, but the present invention is not limited to this, but inspecting processing may be executed based on the result of the differential processing on the image of the wafer 10 (apex section 13) obtained by the two-dimensional camera 36, without installing the line sensor camera 31. Then when it is judged that a defect exists in the apex section 13 in step S107, the two-dimensional image (by the two-dimensional camera 36), corresponding to the angle position having a defect in the apex section 13, can be extracted in the defective image extracting processing, and a step of obtaining the two-dimensional image on the portion having a defect again (by the two-dimensional camera 36) can be omitted.

In this case, if a plurality of images of the apex section 13 is continuously obtained by the two-dimensional camera 36, differential processing may be executed among a plurality of images, without performing the segmenting processing.

The above inspecting apparatus 1 may be used as a monitoring apparatus which monitors the apex section 13 of the wafer 10 without disposing the inspecting section 46. A monitoring method by such a monitoring apparatus comprises a transfer processing (step S101), imaging processing (step S102), segmenting processing (step 5103), differential processing (step S104), histogram generating processing (step S105), and display processing for displaying the differential processing result image and histogram (step S109), just like the above embodiment. In this case as well, the similar effect as the above embodiment can be implemented. The imaging section 30 in this case can have only the line sensor camera 31 or the two-dimensional camera 36.

In the above example, the imaging section obtains images of all around the circumference of the inspection target object, but the imaging section may obtain images of only a part of the circumference of the inspection target object (e.g. ¼ or ⅓ the circumference).

What is claimed is:

1. A monitoring apparatus, comprising:
an imaging section for obtaining images of a first range and a second range of an inspection target object;
the first range being shifted from the first range in a prescribed direction;
a differential processing section for obtaining a difference between signals of the image of the first range and that of the second range; and
a display section for displaying a processing result obtained from the differential processing section.

2. The monitoring apparatus according to claim 1, characterized in that the differential processing section compares a signals of plurality of sections constituting the image of the first range with signals of a plurality of sections constituting the image of the second range, and obtains the respective differences in signal.

3. The monitoring apparatus according to claim 1 or claim 2, further comprising a relative move section for relatively moving the inspection target object in the prescribed direction with respect to the imaging section,
the monitoring apparatus being characterized in that the imaging section continuously obtains images of the inspection target object in the prescribed direction in according with the relative move.

4. The monitoring apparatus according to claim 3, characterized in that
a relative move section rotates the disk-formed inspection target object around a rotation symmetrical axis thereof, so that an outer periphery edge section of the inspection target object moves toward the prescribed direction with respect to the imaging section, and
the imaging section continuously obtains images of an outer periphery edge section of the inspection target object or a portion connected to the outer periphery edge section near the outer periphery edge section from at least one of a direction perpendicular to and a direction in parallel with the rotation axis.

5. The monitoring apparatus according to claim 4, characterized in that the imaging section obtains images of all around the circumference of the inspection target object.

6. The monitoring apparatus according to claim 4, characterized in that the imaging section obtains images of a part of the circumference of the inspection target object.

7. The monitoring apparatus according to any one of claims 1 to 6, further comprising a histogram generating section that generates a histogram for indicating a relationship of the differential value obtained from the differential processing section and a position in the inspection target object corresponding to the images from which the difference is obtained.

8. The monitoring apparatus according to claim 7, characterized in that the images from which the difference is obtained based on a histogram can be displayed.

9. The monitoring apparatus according to any one of claims 1 to 8, characterized in that
the imaging section comprises a line sensor for obtaining images of the inspection target object, and
the line sensor continuously obtains images of the inspection target object while relatively moving in the prescribed direction with respect to the inspection target object.

10. The monitoring apparatus according to claim 9, characterized in that the line sensor obtains images of a bright field image on the edge or near the edge of the inspection target object.

11. The monitoring apparatus according to claim 9 or claim 10, comprising an imaging position setting section for setting a relative move range of the line sensor with respect to the inspection target object.

12. The monitoring apparatus according to any one of claims 9 to 11, characterized in that
the imaging section comprises a two-dimensional imaging unit for obtaining images of a two-dimensional image of the inspection target object, and
the display section sets an imaging range of the two-dimensional imaging unit based on the processing result obtained from the differential processing section.

13. An inspecting apparatus, comprising:
an imaging section for obtaining images of a first range and a second range of an inspection target object;
the first range being shifted from the first range in a predetermined direction;
a differential processing section for obtaining a difference between signals of the image of the first range and that of the second range; and
an inspecting section for inspecting the inspection target object based on processing results obtained from the differential processing section.

14. The inspecting apparatus according to claim 13, characterized in that the differential processing section compares signals of a plurality of sections constituting the image of the first range with signals of a plurality of sections constituting the image of the second range, and obtains the respective differences in signal.

15. The inspecting apparatus according to claim 13 or claim 14, further comprising a display section for displaying processing results obtained from the differential processing section.

16. The inspecting apparatus according to any one of claims 13 to 15, comprising a histogram generating section that generates a histogram for indicating a relationship of the differential value obtained from the differential processing section and a position in the inspection target object corresponding to the images from which the difference is obtained.

17. The inspecting apparatus according to claim 16, characterized in that the inspecting section determines the existence of a defect when the differential value obtained from the differential processing section is greater than a prescribed threshold, and specifies a position of the defect based on the histogram generated by the histogram generating section.

18. The inspecting apparatus according to any one of claims 13 to 17, characterized in that
the imaging section comprises a line sensor for obtaining images of the inspection target object, and
the line sensor continuously obtains images of the inspection target object while relatively moving in the prescribed direction with respect to the inspection target object.

19. The inspecting apparatus according to claim 18, characterized in that
the imaging section comprises a two-dimensional imaging unit for obtaining images of a two-dimensional image of the inspection target object, and
the display section sets an imaging range of the two-dimensional imaging unit based on the inspection result by the inspecting section.

20. The inspecting apparatus according to claim 19, comprising a recording section that records the two-dimensional image in which the defect images are shown by the two-dimensional imaging unit,
the inspecting apparatus characterized in that the inspecting section discerns a type of defect based on the differential value obtained from the differential processing section, according to the type of defect that is classified based on the two-dimensional image recorded in the recording section.

21. The inspecting apparatus according to claim 20, characterized in that the inspecting section extracts color information from the difference obtained from the differential processing section, and inspects the existence of the defect due to a thin film formed on the inspection target object, by inspecting the existence of a prescribed interference color based on the extracted color information.

22. A monitoring method, comprising:
an imaging processing step for obtaining images of a first range and a second range of an inspection target object;
the first range being shifted from the first range in a prescribed direction;
a differential processing step for obtaining a difference between signals of the image of the first range and that of the second range; and
a display processing step for displaying a processing result obtained from the differential processing step.

23. The monitoring method according to claim 22, characterized in that in the differential processing section compares signals of a plurality of sections constituting the image of the first range with signals of a plurality of sections constituting the image of the second range, and obtains the respective differences in signal.

24. An inspecting method, comprising:
an imaging processing step for obtaining images of a first range and a second range of an inspection target object;
the first range being shifted from the first range in a predetermined direction;
a differential processing step for obtaining a difference between signals of the image of the first range and that of the second range; and
an inspection processing step for inspecting the inspection target object based on the processing results obtained from the differential processing step.

25. The inspecting method according to claim 24, characterized in that in the differential processing section compares signals of a plurality of sections constituting the image of the first range with signals of a plurality of sections constituting the image of the second range, and obtains the respective differences in signal.

26. The inspecting method according to claim 24 or claim 25, characterized in that in the inspecting processing step, the existence of the defect is determined when the differential value obtained from the differential processing step is greater than a prescribed threshold.

27. The inspecting method according to claim 26, characterized in that
the imaging section for executing the imaging processing step comprises a two-dimensional image sensor and line sensor for obtaining images of the inspection target object, and is constituted to execute the inspecting processing step based on processing results of the differential processing step on the images of the inspection target object obtained by the line sensor,
the method further executing:
a threshold setting processing step for determining a correlation of the differential value obtained from the differential processing step on the image of the inspection target object obtained by the two-dimensional image sensor and a defect of the inspection target object that can be visually recognized in the image of the inspection target object obtained by the two-dimensional image sensor, and setting the threshold corresponding to the two-dimensional image sensor; and
a threshold correcting processing step for correcting the threshold which is set in the threshold setting processing step and setting the threshold corresponding to the line sensor based on the differential value obtained from the differential processing step on the image of the inspection target object obtained by the line sensor, and setting the threshold corresponding to the line sensor.

28. The inspecting method according to claim 27, characterized in that the inspecting processing step is executed using a circuit board which can execute predetermined computing processing step.
